(19) United States
(12) Patent Application Publication
(10) Pub. No.: US 2024/0350967 A1
(43) Pub. Date: Oct. 24, 2024

(54) SORBENTS AND METHODS FOR CARBON CAPTURE VIA CALCIUM LOOPING

(71) Applicant: ULI LIMITED PARTNERSHIP, Calgary (CA)

(72) Inventors: Seyed Mojtaba HASHEMI, Calgary (CA); Davood KARAMI, Calgary (CA); Nader MAHINPEY, Calgary (CA)

(21) Appl. No.: 18/691,764

(22) PCT Filed: Sep. 8, 2022
(86) PCT No.: PCT/CA2022/051341

§ 371 Date: Mar. 13, 2024

Related U.S. Application Data
(60) Provisional application No. 63/243,512, filed on Sep. 13, 2021.

(51) Int. Cl. B01D 53/14; B01J 20/28; B01J 20/30

(52) U.S. Cl. CPC B01D 53/1475; B01J 20/28004; B01J 20/28019; B01J 20/28059; B01J 20/28071; B01J 20/3007; B01J 20/305; B01J 20/3078; B01D 2253/1122; B01D 2257/504

(57) ABSTRACT

The present disclosure provides CO2 sorbent materials and methods of producing the same. The method includes: (a) combining calcium, at least one metal, and a fuel in a solvent to form a solution; (b) heating the solution formed in (a) to evaporate the solvent and form a combustion mixture; (c) heating the combustion mixture formed in (b) to combustion, to form a combusted material; and (d) calcinating the combusted material formed in (c) to form the CO2 sorbent. The CO2 sorbent may be used for capturing CO2, such as in a calcium looping process.

### CROSS REFERENCE TO RELATED APPLICATION

This application claims priority to U.S. Provisional Patent Application No. 63/243,512, filed Sep. 13, 2021, the entire contents of which is hereby incorporated by reference.

### FIELD

The present disclosure relates generally to calcium oxide-based sorbents for high temperature carbon capture via calcium looping.

### BACKGROUND

Atmospheric carbon dioxide concentration has increased by more than 25% since 1970, reaching a historical maximum of 415 ppm. The devastating effects of climate change (e.g. rising maximum temperatures and rising sea levels) have been linked to the increase of greenhouse gases in the earth's atmosphere. Carbon dioxide accounts for three quarters of the global anthropogenic greenhouse gas emissions with the majority of CO₂ produced from burning fossil fuels. The major point sources of CO₂ emissions are fossil fuel power plants that burn coal or natural gas to produce electricity. While renewable energies and net-zero sources of energy are increasing their share in the energy portfolio, the world still heavily relies on fossil fuels for energy production and the predicted scenarios indicate significant reliance on fossil fuels for energy production through the next few decades. Until a complete conversion to a renewable/net-zero energy portfolio, post-combustion carbon capture allows for continuing to use fossil fuels with minimal CO₂ emissions into the atmosphere.

Among post-combustion capture technologies calcium looping (CaL) is a promising method for integration with fossil fuel power plants. The high temperature of the flue gas from power plants is convenient for a calcium looping process that operates at elevated temperatures. The main impediment for large-scale application of the calcium looping process is the drop in the activity of the calcium-based materials when used in cyclic operations. Natural limestone sorbents are cheap and widely available but suffer from excessive loss of activity and CO₂ uptake capacity. There is therefore a need for highly stable materials that are able to capture CO₂ efficiently through multiple cycles of carbonation and calcination.

### BRIEF DESCRIPTION OF THE DRAWINGS

Embodiments of the present disclosure will now be described, by way of example only, with reference to the attached Figures.

FIG. 1 shows XRD patterns of crystalline structure composition of sorbents synthesized with different fuels. Peak analysis indicates formation of crystalline CaZrO₃ phase.

FIG. 2 shows the XRD patterns of sorbents stabilized with carious metal oxides. Vertical dashed lines indicate CaO, whereas dots indicate stabilizer phase.

FIG. 3 shows pore size distribution of powdered sorbents produced from citric acid precursor.

FIG. 4 shows SEM images of sorbents produced from (a) CA and (b) BA at stoichiometric ratio. Sorbents produced from CA are characterized by a porous fluffy structure, whereas BA-derived sorbents are rougher and denser.

FIG. 5 shows SEM/EDX elemental mapping of fresh and spent sorbents. (a) BA20-1x fresh, (b) CA20-1x fresh, (c) CA20-1x mild calcination, (d) CA20-1x harsh calcination. Mild calcination was performed under nitrogen at 850° C., while harsh calcination was under 50% CO₂ at 900° C.

FIG. 6 shows the SEM images and EDX elemental mapping of sorbents (a) before and (b) after 100 cycles of carbonation and calcination under harsh conditions.

FIG. 7 shows TEM images of (a) and (b) BA20-1x sorbent; (c) and (d) CA20-1x sorbent.

FIG. 8 shows cyclic performance of samples prod (a) CA and (b) BA. CA-derived samples are more stable with higher uptake capacity over 20 cycles of carbonation/calcination. Carbonation under 20% CO₂ balanced with nitrogen at 675° C. Calcination under nitrogen at 850° C.

FIG. 9 shows uptake capacity and rate of BA20-4x sample over cycles. Mild calcination conditions under nitrogen at 850° C.

FIG. 10 shows the effect of presence of zirconium in samples. Sorbents without zirconium exhibit a drop in uptake capacity over cycles, whereas sorbents with 20% calcium zirconate are more stable in cyclic operation.

FIG. 11 shows the cyclic performance of sorbents stabilized with different metal oxides under (a) mild, and (b) harsh calcination conditions.

FIG. 12 shows the effect of spheronization on the performance of CA20-1x sorbents. Spherical particles were tested under two carbonation durations, 20 mins and 35 mins for normal and long carbonation cycles, respectively.

FIG. 13 shows CO₂ uptake capacity and uptake rate of powdered and spherical sorbent during the 1^{st} (A), and 20^{th} (B) cycles.

FIG. 14 shows the performance of synthetic pellets in a reactor setting compared to that of natural limestone sorbent.

### DETAILED DESCRIPTION

Generally, the present disclosure provides sorbents ideal for use in the calcium looping process. The sorbents according to embodiments disclosed herein have a high uptake capacity, as well as a significant stability over cyclic carbonation/calcination conditions under realistic and industrially relevant conditions.

The reason for loss in the uptake capacity of existing CaO-based sorbents is the sintering of these sorbents at high temperatures, which results in the destruction of the porous structure and agglomeration of ultrafine particles. The Tammann temperature of CaCO₃ is 533° C., significantly lower than the calcination temperature of 850-950° C. This results in extensive sintering of CaO sorbents and a rapid drop in the uptake capacity. To prevent sintering of CaO sorbents, metal oxide supports with high Tammann temperatures may be added to the structure of the sorbent, such as MgO, Y₂O₃, SiO₂, CeO₂, Al₂O₃, and ZrO₂.

ZrO₂ stabilized CaO sorbents have been previously fabricated through different synthesis routes including sol-gel, coprecipitation, and flame spray pyrolysis. Higher zirconium percentage enhanced the stability of the sorbent but reduced the uptake capacity due to reduction in the active sorbent percentage. The stabilizing effect of zirconium was found to be due to the formation and homogeneous dispersion of CaZrO₃ phase with a high Tammann temperature (1036° C.) resulting in reduced sintering of the sorbent. Twenty percent CaZrO₃ was found to give the optimum results in terms of uptake capacity and stability among the performed experiments.

Most synthesis techniques lead to production of sorbents in the powder form, which is not suitable for large-scale applications, due to facing issues such as elutriation and high pressure drop when used in fixed and fluidized bed systems. Therefore, powders are required to be shaped as granules or pellets prior to being tested in bench-scale or pilot-scale calcium looping systems for their ultimate practical application.

By contrast, sorbents prepared by the methods herein disclosed are more ideal for use in the calcium looping process. An ideal sorbent must have a high uptake capacity, as well as a significant stability over cyclic carbonation/calcination conditions under realistic and industrially relevant conditions. To scale up the CaL process, spheronization of the optimum sorbents has been conducted and the spherical particles tested in a thermogravimetric analyzer for their carbon capture performance. The current disclosure presents a method for production of highly stable sorbents for the calcium looping process using a simple and scalable process. The prior methods for production of such sorbents are lengthy, complicated, and difficult to scale up, whereas the herein disclosed method introduces a route for production of stable sorbents through few simple and scalable steps. The short combustion time is a characteristic of this method and a key parameter in production of fine sorbents with desirable textural properties. Moreover, the physical properties of the sorbents produced through the herein disclosed method in terms of surface area and dispersion of the stabilizing metal are significantly improved over prior art.

In one aspect, the present disclosure provides a method of producing a CO2 sorbent, the method comprising: (a) combining calcium, at least one metal, and a fuel in a solvent to form a solution; (b) heating the solution formed in (a) to evaporate the solvent and form a combustion mixture; (c) heating the combustion mixture formed in (b) to combustion, to form a combusted material; and (d) calcinating the combusted material formed in (c) to form the CO2 sorbent.

In one or more embodiments, the calcium in (a) may be a water-soluble calcium salt. The water-soluble calcium salt may be any suitable calcium salt, such as calcium nitrate or calcium chloride. The calcium in (a) may be calcium nitrate (Ca(NO₃)₂·xH₂O), such as Ca(NO₃)₂·4H₂O.

In one or more embodiments, the at least one metal may be zirconium, magnesium, aluminum, or a rare earth metal such as lanthanum, neodymium, cerium, or ytterbium. The at least one metal may be in the form of a water-soluble metal salt, such as a metal nitrate. The at least one metal may be any suitable metal salt, such as ZrO(NO₃)₂·6H₂O, Mg(NO₃)₂·6H₂O, or Al(NO₃)₂·9H₂O.

In one or more embodiments, the fuel may be citric acid, β-alanine, urea, or ethylenediaminetetraacetic acid (EDTA). The fuel may be citric acid.

In one or more embodiments, the calcium in (a) is Ca(NO₃)₂·4H₂O, the at least one metal is ZrO(NO₃)₂·6H₂O, and the fuel is citric acid.

In one or more embodiments, the solvent in (a) is any suitable solvent for solubilizing the precursors. The solvent in (a) may be water, ethylene glycol, or ethanol. The solvent in (a) may be water. The solution in (a) may be an aqueous solution.

In one or more embodiments, the CO₂ sorbent comprises a stabilizer. The stabilizer may be a metal oxide. The stabilizer may be any suitable metal oxide, such as CaZrO₃, Al₂O₃, MgO, Y₂O₃, CeO₂, La₂O₃, or Nd₂O₃. The stabilizer may be CaZrO₃.

In one or more embodiments, the CO₂ sorbent has a surface area of about 15 m²/g to about 42 m²/g. The CO₂ sorbent may have a surface area of about 15 m²/g to about 20 m²/g, or about 20 m²/g to about 25 m²/g, or about 25 m²/g to about 30 m²/g, or about 30 m²/g to about 35 m²/g, or about 35 m²/g to about 40 m²/g, or about 40 m²/g to about 45 m²/g, or about 35 m²/g to about 45 m²/g, or about 35 m²/g to about 42 m²/g, or about 30 m²/g to about 42 m²/g, or about 25 m²/g to about 40 m²/g, or about 20 m²/g to about 42 m²/g, or about 40 m²/g to about 42 m²/g.

In one or more embodiments, the CO₂ sorbent has a pore volume of about 0.02 cm³/g to about 0.12 cm³/g. The CO₂ sorbent may have a pore volume of about 0.02 cm³/g to about 0.04 cm³/g, or about 0.025 cm³/g to about 0.05 cm³/g, or about 0.02 cm³/g to about 0.06 cm³/g, or about 0.03 cm³/g to about 0.06 cm³/g, or about 0.04 cm³/g to about 0.06 cm³/g, or about 0.04 cm³/g to about 0.08 cm³/g, or about 0.05 cm³/g to about 0.075 cm³/g, or about 0.05 cm³/g to about 0.1 cm³/g, or about 0.06 cm³/g to about 0.1 cm³/g, or about 0.075 cm³/g to about 0.1 cm³/g, or about 0.08 cm³/g to about 0.1 cm³/g, or about 0.08 cm³/g to about 0.12 cm³/g, or about 0.1 cm³/g to about 0.12 cm³/g.

In one or more embodiments, the heating in (b) is at a temperature sufficient to evaporate the solvent. The heating in (b) may be at about room temperature to about the boiling point of the solvent. If the solvent is water, the heating in (b) may be at about room temperature to about 100° C. or more. The temperature in (b) may be a temperature of about 20° C. to about 600° C., such as about 100° C. The temperature in (b) may be a temperature of about 20° C. to about 100° C., or about 20° C. to about 50° C., or about 20° C. to about 300° C., or about 100° C. to about 200° C., or about 200° C. to about 300° C., or about 300° C. to about 400° C., or about 400° C. to about 500° C., or about 500° C. to about 600° C., or about 20° C. to about 200° C., about 100° C. to about 300° C., about 200° C. to about 400° C., or about 300° C. to about 500° C., or about 400° C. to about 600° C., or about 300° C. to about 600° C., or about room temperature, or about 25° C., or about 50° C., or about 100° C., or about 200° C., or about 300° C., or about 400° C., or about 500° C., or about 600° C. or greater than 600° C. It will be understood that any suitable means of removing the solvent may be used; for example, (b) may be carried out at a reduced temperature and pressure.

In one or more embodiments, the heating in (c) is at a temperature sufficient to combust the fuel, or to initiate combustion of the fuel. The heating in (c) may be at a temperature of about 500° C. The heating in (c) may be at a temperature of about 200° C. to about 300° C., or about 300° C. to about 400° C., or about 400° C. to about 500° C., or about 500° C. to about 600° C., or about 200° C. to about 400° C., or about 300° C. to about 500° C., or about 400° C. to about 600° C., or about 300° C. to about 600° C., or about 600° C. or greater than 600° C. The heating in (c) may occur for an amount of time sufficient to combust the fuel. The heating in (c) may occur for an amount of time sufficient for the fuel to reach the combustion temperature, or longer. The combustion in (c) may occur for less than 1 minute per gram of combustion mixture, such as for about 1 to about 60 seconds, or about 1 to about 30 seconds, or about 1 to about 15 seconds, or about 5 to about 30 seconds, or about 60 seconds or more than 60 seconds.

In one or more embodiments, the calcinating in (d) is at atmospheric pressure and at a temperature of about 700° C. to about 1000° C., such as about 900° C. The calcinating in (d) may be at atmospheric pressure. The calcinating in (d) may be at reduced pressure, such as under vacuum conditions. The calcinating in (d) may be under vacuum conditions and at a temperature of about 500° C. to about 1000° C., such as about 500° C. The calcinating in (d) may be at a temperature of about 500° C. to about 1000° C., or about 500° C. to about 700° C., or about 700° C. to about 1000° C., or about 600° C. to about 800° C., or about 700° C. about 800° C., or about 800° C. to about 900° C., or about 800° C. to about 1000° C., or about 900° C. to about 1000° C., or about 850° C. to about 950° C., or about 900° C. The calcinating in (d) may occur for any amount of time suitable to calcinate the combusted material formed in (c). The calcinating in (d) may occur for a period of about 0.5 to about 2 hours, or about 0.5 hours, or about 1 hour, or about 1.5 hours, or about 2 hours, or about 1 hour to about 2 hours, or about 2 hours or more than 2 hours.

The method according to one or more embodiments herein described may be carried out in any suitable vessel. The method may be carried out in a vessel that allows the released gases to exit to the surrounding environment but contains the solids inside. Such a vessel may incorporate outlet valves that allow escape of gases but not solids. The method may be carried out in a vessel that is able to maintain a high pressure because of the high quantities of released combustion gases. Such a vessel may allow the gases to be released slowly using a pressure relief valve or any other suitable type of valve.

In one or more embodiments, the method may further comprise: (e) extruding the CO₂ sorbent formed in (d) to form an extruded material. The extruding in (e) may comprise combining the CO₂ sorbent formed in (d) with organic and/or inorganic additives prior to extruding. The organic additive(s) in (e) may be any additive suitable for improving the rheological properties of the produced pastes. The organic additive(s) may be cellulose, glycerol, and/or water. The inorganic additive in (e) may be any suitable additive, such as calcium aluminate, to enhance thermal and/or mechanical stability of sorbents for high temperature calcination. The extruding in (e) may comprise combining the CO₂ sorbent formed in (d) with cellulose and calcium aluminate cement binder in water and glycerol.

In one or more embodiments, the method may further comprise spheronizing the CO₂ sorbent. The method may comprise (f) spheronizing the extruded material formed in (e) to form a granular material. The granular material formed in (f) may comprise spherical particles having average diameters of about 100 μm to about 5 mm, such as about 2-3 mm. The granular material may be generally spherical. The granular material may comprise particles having average diameters of about 1 mm to about 5 mm, or about 1 mm to about 2 mm, or about 2 mm to about 4 mm, or about 3 mm to about 5 mm, or about 4 mm to about 5 mm, or more than 5 mm, or less than 1 mm, or about 100 μm to about 200 μm, or about 100 μm to about 500 μm, or about 100 μm to about 1 mm, or less than 100 μm.

In one or more embodiments, the method may further comprise pelletizing the CO₂ sorbent formed in (d) or the extruded material formed in (e).

In one aspect, there is provided a CO₂ sorbent material obtainable or obtained by the method according to an embodiment of the present disclosure. In one aspect, there is provided a use of the CO₂ sorbent material for capturing CO₂. In one aspect, there is provided a process for removing CO₂ from a gas stream, the process comprising passing the gas stream over the CO₂ sorbent material. In one aspect, there is provided a calcium looping process using the CO₂ sorbent material.

Method of the invention are conveniently practiced by providing the compounds and/or compositions used in such method in the form of a kit. Such kit preferably contains the composition. Such a kit preferably contains instructions for the use thereof.

To gain a better understanding of the invention described herein, the following examples are set forth. It should be understood that these examples are for illustrative purposes only. Therefore, they should not limit the scope of this invention in anyway.

### Examples

### Materials and Sorbent Preparation.

The precursor chemicals calcium nitrate tetrahydrate (Ca(NO₃)₂·4H₂O), zirconium oxynitrate hexahydrate (ZrO(NO₃)₂·6H₂O), magnesium nitrate hexaydrate (Mg(NO₃)₂·6H₂O), aluminum nitrate nonahydrate (Al(NO₃)₂·9H₂O) and citric acid were purchased from Sigma-Aldrich, and β-alanine was purchased from Alfa Aesar. Synthetic sorbents were fabricated using the solution combustion synthesis method with citric acid (CA) and β-alanine (BA) as fuel. The ratio of CaZrO₃ was fixed at 20% mass in all samples except one reference sample with no CaZrO₃ stabilizer. The amount of fuel was calculated based on propellant chemistry to balance the amount of oxidizing (metal nitrates) and reducing (fuel) agents in the solution.

In the combustion reaction, metals (Ca, Zr, Mg, and Al), carbon, and hydrogen are reducing elements with corresponding valences of Ca (+2), Zr (+4), Mg (+2), Al (+3) carbon (+4), and hydrogen (+1). Oxygen acts as oxidizer and has a valence of (−2), and nitrogen has zero valence. Based on the elemental valences, the reducing valence of the fuels and the oxidizing valence of the metal nitrates can be calculated. For example, the reducing valence of CA (C₆H₈O₇) is (6(4)+8(1)+7(−2))=+18, whereas the oxidizing valence of Ca(NO₃)₂·4H₂O is (2+2(0)+6(−2)+8(1)+4(−2))=−10. Accordingly, the stoichiometric amount of fuel required for complete reduction of metal nitrates can be calculated.

Predetermined amounts of calcium and zirconium precursors as well as the fuel were dissolved in deionized water. The solution was stirred on a hotplate with a magnetic stirrer at 60° C. until the solids were completely dissolved in water. The hotplate temperature was then set to maximum heating (500° C.) until all the water is evaporated. Shortly after evaporation of the water the solid residue combusted vigorously in the Pyrex beaker with evolution of large amount of gases. The Pyrex beaker was covered with an aluminum foil with small holes to contain the combustion and allow the produced gases to escape. A blackish powder was produced after the combustion reaction and was collected from the beaker and calcined at 900° C. for 2 hours in a furnace.

### Extrusion and Spheronization.

Powdered sorbents were further spheronized using a Caleva Multi Lab bench-top extrusion and spheronization equipment. First, a batch of powdered sorbents was put in the granulator attachment of the equipment, along with a predetermined amount of cellulose, and 10 weight percent of commercial calcium aluminate cement binder (Almatis Inc., CA-14). Then, water and glycerol were added dropwise to produce a paste. The granulator mixed the contents with inter-meshing counter rotating blades, producing a well-mixed paste. Then, the paste was injected in the extruder unit through a die with holes of 1 mm diameter and 1 mm depth. The extrudates were cut into appropriate sizes depending on the desired size of the spheres, before feeding to the spheronizer unit. The spheronizer unit rotated at 1500 RPM to produce spherical particles of 2-3 mm diameter.

### Characterization.

Crystalline phase structure was determined using X-ray diffraction (XRD) measurements by a Siemens D500 diffractometer with Cu-Kα radiation over the angular range (2θ) of 10-60°. Jade 7 XRD MDI library was used to identify the peaks in the XRD pattern.

Surface morphology was examined using scanning electron microscopy (SEM) with a JOEL model 7001F field-emission gun. Elemental mapping of the samples were determined using the EDX analyzer attached to the SEM.

Surface measurements were carried out using Micrometrics ASAP2020 volumetric adsorption analyzer. Nitrogen adsorption/desorption isotherms at −196° C. were obtained with pressure values ranging from about 1 to 760 mmHg. The BET surface area and BJH pore size distribution (PSD) were determined accordingly.

High-angle angular dark field (HAADF) images were taken using a transmission electron microscope (TEM, Hitachi 7650) operating at 60 kV.

### CO₂ Capture Assessment.

The performance of the synthetic sorbents was assessed in a Thermogravimetric Analyzer (TGA, Pyris-STA6000). 10-30 mg of sample was placed in the crucible and tested in 20 or 50 cycle experiments. Carbonation was performed at 675° C. in a 20% CO₂ in nitrogen atmosphere. Calcination was performed in two different settings: mild calcination at 850° C. under nitrogen; and harsh calcination at 950° C. under CO₂. Samples were tested in 20-cycle experiments to assess cyclic performance and stability. The CO₂ uptake capacity was calculated on a g/g basis as follows:

$${CO}_{2} uptake at {i}^{th} cycle ( g {CO}_{2} per g sorbent ) = \frac{{m}_{i} - {m}_{i 0}}{{m}_{0}} ,$$

where mᵢ is the weight of the sample after the i^{th} carbonation cycle, mᵢ₀ is the weight of the sample after the i^{th} calcination cycle, m₀ is the weight of the completely calcined sorbent.

### Sample Synthesis.

Generally, solution combustion reactions are sufficiently exothermic to provide high synthesis temperatures and propagation of combustion wave. If not appropriately controlled, these reactions may lead to explosion with a rapid release of large quantities of gases over a short reaction time. In the present work, synthesis with BA was more explosive than CA at stoichiometric ratio. For both fuels, increasing the fuel-to-oxidizer ratio resulted in a less vigorous combustion reaction. For CA, the redox reaction was non-explosive and without a visible flame, whereas for BA at stoichiometric fuel ratio, the reaction was explosive and had a visible flame.

In the synthesis process a redox reaction between the metal nitrates and the fuel results in a combustion reaction characterized by the production of large amount of gases. The overall redox reaction for CA as fuel is shown below:

$${αCa ( {NO}_{3} )}_{2} \text{.4} {H}_{2} O + {βZrO ( {NO}_{3} )}_{2} \text{.6} {H}_{2} O + {χC}_{6} {H}_{8} {O}_{7} + {δO}_{2} \to εCaO + {ϕCaZrO}_{3} + {φCO}_{2} + {γH}_{2} O + {ηN}_{2} + {κO}_{2} \qquad ( R 1 )$$

Based on reaction (R1), increasing the fuel-to-oxidizer ratio leads to an increase in the number of moles of gaseous products. The quantity of released gases is postulated to impact the properties of the resulting sorbents including surface area and morphology. It must also be noted that for fuel-rich mixtures, there is a deficiency of oxygen in the solution mixture for complete oxidation of the fuel. Therefore, the required oxygen will be supplied by atmospheric air.

TABLE 1
Stoichiometric coefficients of the combustion reaction for synthesis with CA and
BA, standard formation enthalpy of the reaction (ΔH_{f}⁰), and the adiabatic combustion
temperature of the reaction (T_{ad}), for different fuel-to-oxidizer ratios (CA:M)

| | F:M^{a} molar | | | | | | |
|---|---|---|---|---|---|---|---|
| | ratio | α | β | χ | δ | ε | ϕ |
| Citric | 5:9 | 1 | 0.07 | 0.60 | 0.00 | 0.93 | 0.07 |
| Acid | (stoich.) | | | | | | |
| (CA) | 10:9 | 1 | 0.07 | 1.19 | 2.68 | 0.93 | 0.07 |
| | 20:9 | 1 | 0.07 | 2.38 | 8.04 | 0.93 | 0.07 |
| β-alanine | 2:3 | 1 | 0.07 | 0.72 | 0.00 | 0.93 | 0.07 |
| (BA) | (stoich.) | | | | | | |
| | 4:3 | 1 | 0.07 | 1.43 | 2.68 | 0.93 | 0.07 |
| | 8:3 | 1 | 0.07 | 2.86 | 8.04 | 0.93 | 0.07 |

| | F:M^{a} molar | | | | Moles of | ΔH⁰ | T_{ad} |
|---|---|---|---|---|---|---|---|
| | ratio | φ | γ | η | G/S^{b} | (kJ · mol⁻¹) | (K) |
| Citric | 5:9 | 3.58 | 6.82 | 1.07 | 11.5 | −526 | 1282 |
| Acid | (stoich.) | | | | | | |
| (CA) | 10:9 | 7.15 | 9.20 | 1.07 | 17.5 | −1589 | 2074 |
| | 20:9 | 14.30 | 13.97 | 1.07 | 29.3 | −3716 | 2629 |
| β-alanine | 2:3 | 2.15 | 6.94 | 1.43 | 10.5 | −513 | 1360 |
| (BA) | (stoich.) | | | | | | |
| | 4:3 | 4.29 | 9.44 | 1.79 | 15.5 | −1563 | 2283 |
| | 8:3 | 8.58 | 14.45 | 2.50 | 25.5 | −3664 | 2965 |

^{a}F: CA or BA, M: Ca and Zr;
^{b}G: gaseous product, S: solid product

Table 1 shows the stoichiometric coefficients of the synthesis reaction with CA. From the balanced equation, the molar ratio of the gaseous products to the solid products is calculated. For fuel-rich solutions, combustion of the excess fuel produces additional heat that results in an increase in the theoretical adiabatic combustion temperature (T_{ad}). The combustion reaction occurs in a matter of seconds and there may not be sufficient time for oxygen to reach the fuel from the surrounding environment. In such conditions, the excess fuel will decompose rather than combust, due to lack of oxygen. For CA, the decomposition reaction proceeds as follows:

$${C}_{6} {H}_{8} {O}_{7} \to 6 C + 4 {H}_{2} O + 1.5 {O}_{2} \qquad ( R 2 )$$

The formation of carbon according to the above reaction explains the blackish color of the produced powders after the combustion reaction. Other factors contributing to the difference between the observed and the theoretical combustion temperatures include radiative losses, and dissipation of heat for heating up the reaction container.

TABLE 2
Surface properties of sorbents characterized by nitrogen adsorption.

| | | BJH Adsorption | Average |
|---|---|---|---|
| | BET Surface | Pore | Pore |
| | Area | Volume | Width |
| Sample ID | (m²/g) | (cm³/g) | (Å) |
| CA0-1x | 19.7 | 0.0887 | 182 |
| CA20-1x | 30.0 | 0.1089 | 146 |
| CA20-1x spheres | 15.9 | 0.0517 | 221 |
| 900C calcined | | | |
| CA20-1x spheres | 16.2 | 0.0669 | 168 |
| 20 cycle mild TGA | | | |
| long carb | | | |
| CA20-4x | 23.3 | 0.0759 | 132 |
| BA20-1x | 9.3 | 0.0201 | 93 |
| BA20-1x 20 cycle | 41.5 | 0.1030 | 105 |
| mild TGA | | | |
| BA20-4x | 20.3 | 0.0374 | 79 |

### Sample Characterization.

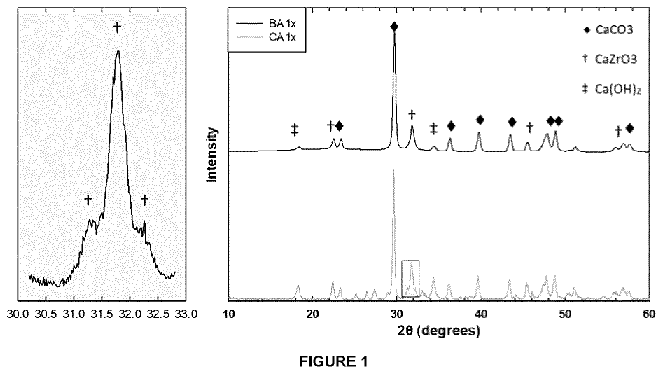

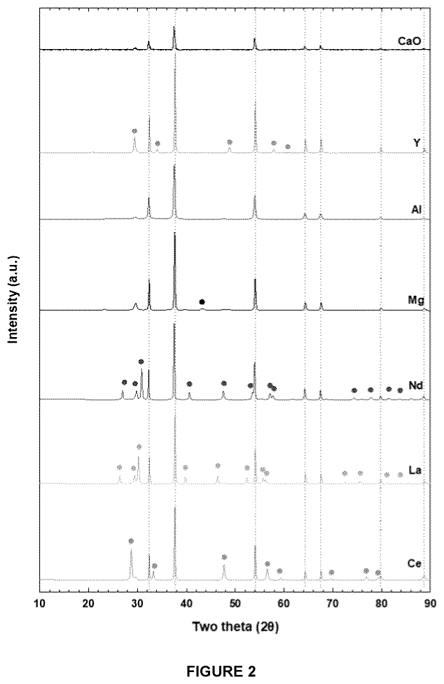

Crystalline structure of the sorbents was determined by XRD analysis. The characteristic XRD patterns of the sorbents synthesized using BA and CA as fuel at stoichiometric ratio are depicted in FIG. 1 and FIG. 2. The peaks belong to various calcium-based compounds namely calcium carbonate, calcium hydroxide, and calcium zirconate, as well as metal oxide stabilizers including MgO, La₂O₃, Nd₂O₃, and Y₂O₃. Due to exposure of the calcined sorbents to air moisture and carbon dioxide, calcium oxide in the sorbents was converted to calcium carbonate and hydroxide as seen in FIG. 1. Zirconium was found in the form of calcium zirconate (CaZrO₃) perovskite, which has a very high Tammann temperature (1036° C.). Without wishing to be bound by any particular theory, it is postulated that the formation of the calcium zirconate phase retards the sintering of the sorbent, resulting in an improved stability over cyclic carbonation-calcination. Calcium zirconate crystals occupy the spaces between calcium oxide crystalline grains, resulting in increased spacing between CaO crystals. The increase in the distance between CaO grains prevents sintering of the crystals during calcination. The vertical dashed lines in FIG. 2 indicate peaks corresponding to CaO, whereas the dots indicate peaks of stabilizer metal oxide.

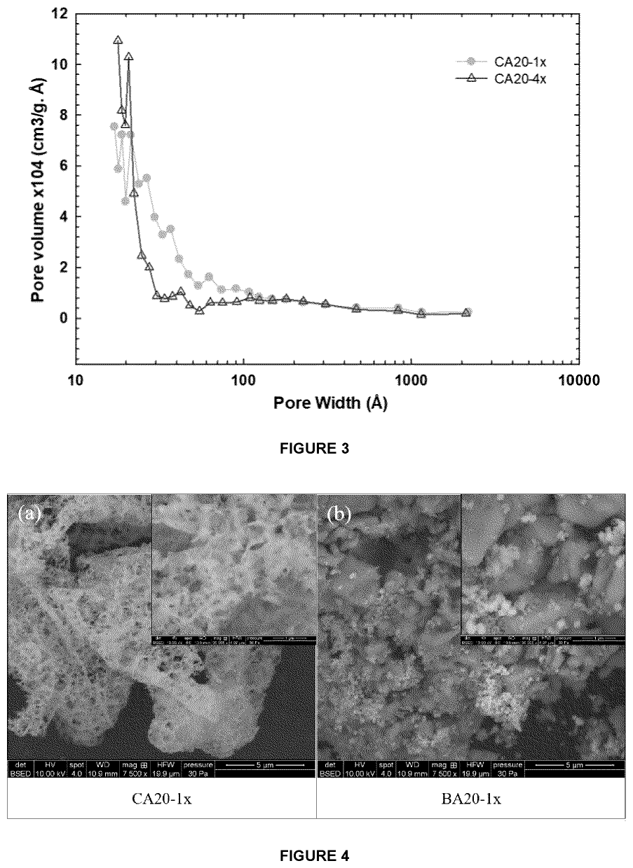

The texture of the sorbents was determined using N₂ sorption-desorption isotherms as summarized in Table 2. Samples synthesized using CA generally exhibit a higher surface area and pore volume compared to sorbents synthesized from BA. The herein produced sorbents exhibit significant advantages in terms of surface and morphological properties compared to prior art. Sorbents exhibit a surface area of as high as 41.5 m²/g, significantly higher than previously produced sorbents using urea that exhibit a surface area in the range of 9-22 m²/g (FIG. 3). The dispersion of the metal stabilizer is also significantly improved compared to prior art as shown by the SEM/EDX results shown in FIG. 5. Urea-produced sorbents showed a somewhat non-uniform dispersion of stabilizer in sorbent, whereas the herein CA-produced sorbents exhibit a surprisingly homogeneous dispersion of the metal stabilizer.

Sorbents synthesized with CA at stoichiometric ratio (CA20-1x) were spheronized and tested in cyclic carbonation-calcination experiments. Spheronization of the sorbents resulted in a decrease in the surface area. It is expected that this is due to the blockage of some pores and conglomeration of ultrafine particles to produce mechanically resistant granules during the extrusion and spheronization process.

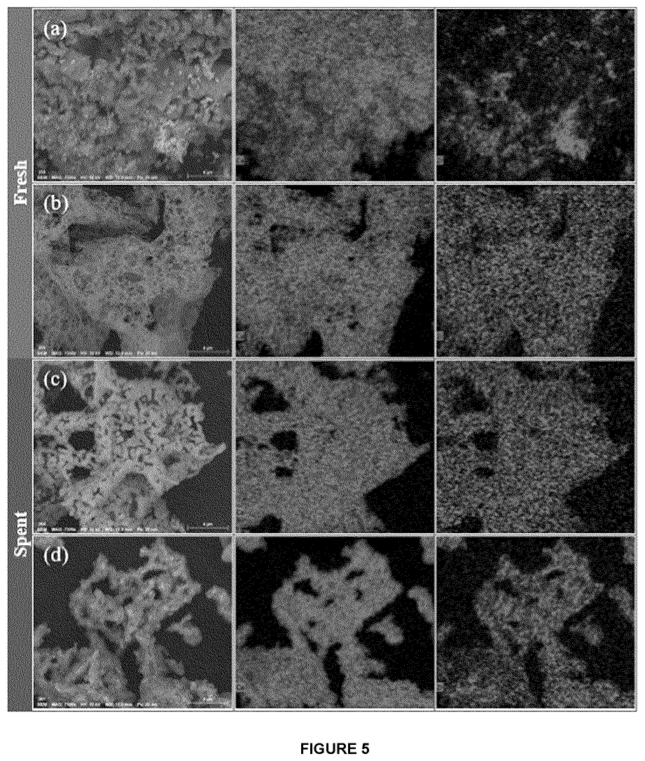

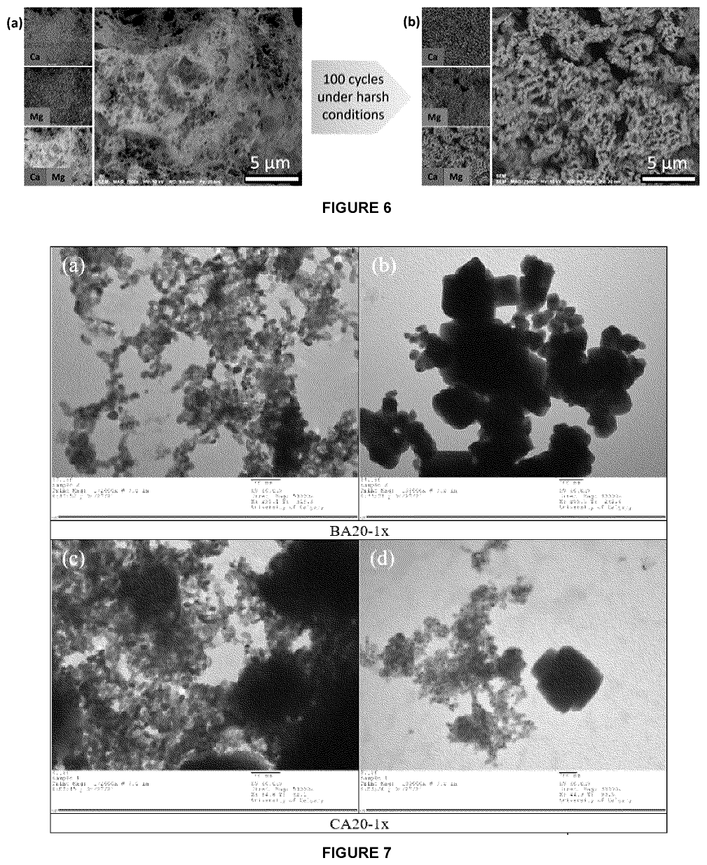

SEM images of samples synthesized from BA and CA at stoichiometric fuel-to-oxidizer ratio are shown in FIG. 4. SEM images indicate that samples synthesized from CA have a porous structure with smaller particle size, consistent with the observed fluffy and voluminous powder during synthesis. BA-synthesized samples (FIG. 4-b) however, are more rough and dense, and exhibit formation of small white grains on the surface in the SEM image. These small white grains are expected to be accumulated CaZrO₃ particles that were unevenly dispersed during synthesis, due to the fast explosion-like reaction. To confirm this, EDX elemental mapping of samples was performed and presented in FIG. 5. As seen in FIG. 5-a, distribution of Zr was uneven for the BA-synthesized sorbents, with more Zr accumulated at the spots corresponding to the white grains in the SEM image. For CA-synthesized samples (FIG. 5-b) however, Zr was homogenously dispersed, which contributes to the improved stability and sintering resistance of the sorbents. SEM/EDX images of the spent sorbents indicate the appearance of white grains for the sorbents calcined under harsh conditions (FIG. 5-d). At elevated temperatures, the increased sintering of the particles results in separation of the CaO and CaZrO₃ crystals due to having different Tammann temperatures. The EDX elemental mapping also confirms the separation of phases with Zr more concentrated at the areas corresponding to the white grains. Under mild calcination conditions, separation of phases was not observed and sorbent was able to maintain a homogenous distribution after cyclic experiments (FIG. 5-c). FIG. 6 shows the SEM image along with EDX elemental mapping of Mg-stabilized sorbent pre- and post-cycling. Images indicate that the sorbent maintains its morphology and porosity after 100 cycles of carbonation and calcination under harsh calcination conditions, demonstrating the superior sintering resistance of the herein developed sorbents.

TEM images of the fresh sorbents (FIG. 7) exhibit nanoparticles with diameters in the range of about 5-20 nm. BA-synthesized samples include areas populated with larger and more dense particles as shown in FIG. 7-b. These are likely corresponding to the regions with larger CaZrO₃ particles in the SEM images (FIG. 4-b). CA-synthesized samples exhibited a more homogenous structure under the TEM microscope, consistent with the previous characterization results with SEM and EDX.

### Capture Performance.

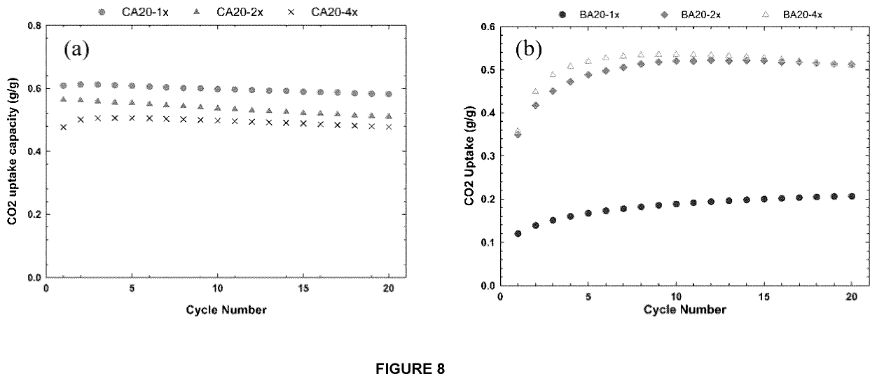

CO₂ capture performance of the sorbents was tested in cyclic carbonation/calcination experiments in a TGA. FIG. 8 shows the performance of the sorbents in 20 cycles of experiments. CA-synthesized sorbents exhibit a significant uptake capacity and stability under mild calcination conditions, with a 1^{st} cycle and 20^{th} cycle uptake of 0.61 and 0.58 g/g, respectively, for the CA20-1x sample. Increase in the fuel-to-oxidizer ratio resulted in a relative decline in the uptake capacity of the CA-synthesized sorbents. This is consistent with the reduced surface area of the sorbents at higher fuel ratios, as discussed above. The higher surface area at the stoichiometric fuel ratio facilitates efficient diffusion of the CO₂ molecules into the pores of the sorbent to reach the unreacted CaO, resulting in a longer fast-carbonation period and therefore, increasing the uptake capacity. For BA-derived sorbents however, uptake capacity increased with increasing fuel-to-oxidizer ratio. This is also consistent with the surface area of the sorbents (Table 2) based on a similar reasoning. CA-synthesized sorbent was selected as the optimum sorbent for further investigations due its superior performance at stoichiometric ratio.

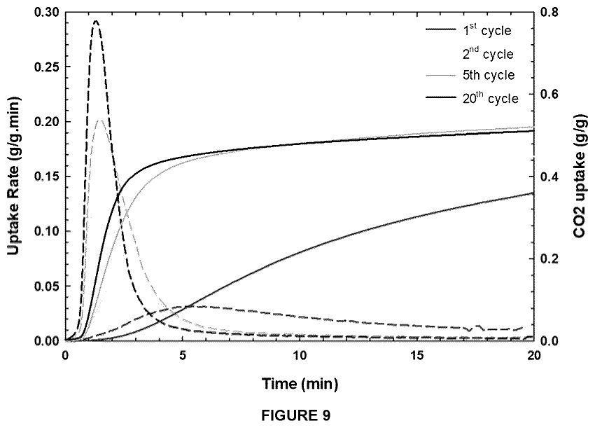

To further investigate the increase in the uptake capacity over cycles for the BA-4x sample, the uptake rate was calculated for each cycle. FIG. 9 shows the uptake capacity and uptake rate for the BA-4x sample over the 1^{st}, 2^{nd}, 5^{th}, and 20^{th} cycles. As explained in above, the surface area and porosity improve after the initial carbonation-calcination cycles. The improved surface area translates into a higher uptake capacity and uptake rate during carbonation, as the higher surface area facilitates a faster reaction between CO₂ and the sorbent. The increasing trend in the uptake rate can be observed in FIG. 9.

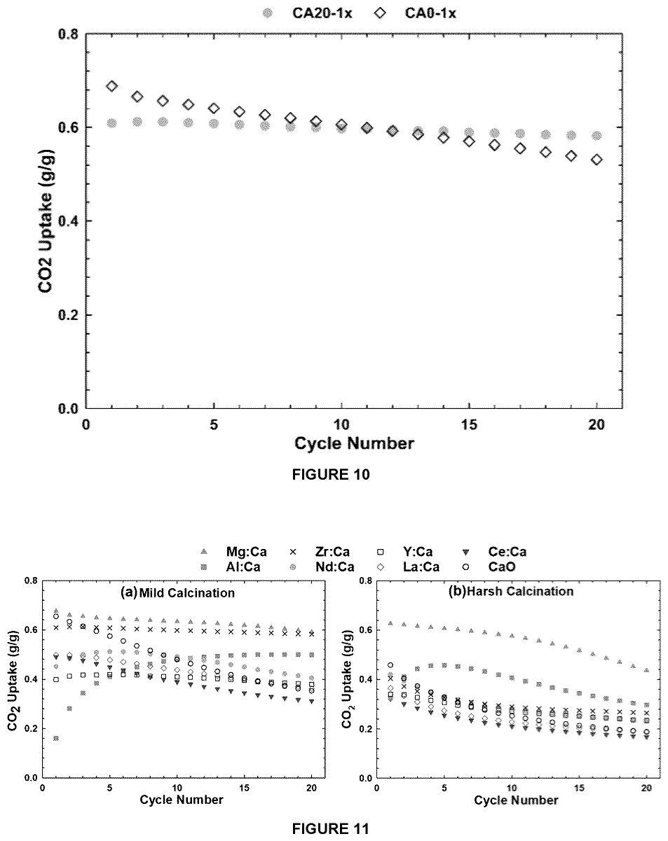

To assess the stabilization effect of CaZrO₃, a sample was synthesized without any zirconium precursor with CA at stoichiometric ratio (CA0-1x). FIG. 10 shows the performance of sorbents with and without calcium zirconate stabilizer. CA0-1x starts with a higher initial uptake capacity due to having a higher percentage of active sorbent. CA20-1x comprises of 80% active CaO for CO₂ capture and 20% of inactive calcium zirconate. The uptake capacity of CA0-1x decays over time, matching the uptake of CA20-1x after about 11 carbonation/calcination cycles. However, CA20-1x sorbents maintain their capture capacity over cycles, exceeding that of the CA0-1x from the 12^{th} cycle onwards. Therefore, addition of CaZrO₃ improves the cyclic stability of the sorbent, while reducing the portion of the active material. This creates competing effects between high uptake capacity and stability. The addition of stabilizer should therefore be limited to the highest percentage that leads to a reasonable stability.

The stabilization effect of different metals was investigated to examine which metal oxide is the optimum stabilizer. FIG. 11 (a) shows the CO₂ uptake capacity of sorbents stabilized with different metal stabilizers over 20 cycles of experiments under mild calcination conditions. Mg and Zr stabilized sorbents exhibit the best performance maintaining most of the capture capacity over the cycles with a minimum drop in the capacity. In the case of the Al-stabilized sorbent, the uptake capacity increases over cycles. This is explained by the improved surface area and porosity, similar to the reasoning for the BA-derived samples presented above.

The cyclic performance of the sorbents under industrially relevant calcination conditions is presented in FIG. 11 (b). Sorbents exhibit an improved performance in comparison to natural sorbents under harsh conditions. However, the stabilization effect of Mg was found to be enhanced in comparison to Zr and Al. Mg-stabilized samples maintained an uptake capacity of 0.43 g/g after 20 cycles of carbonation-calcination at 950° C. and under 50% CO₂.

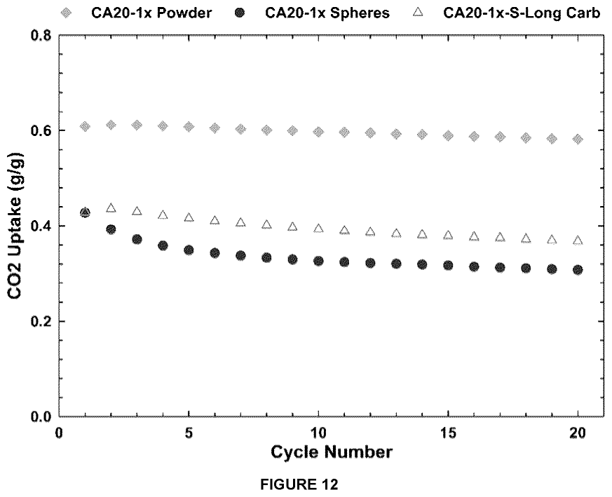

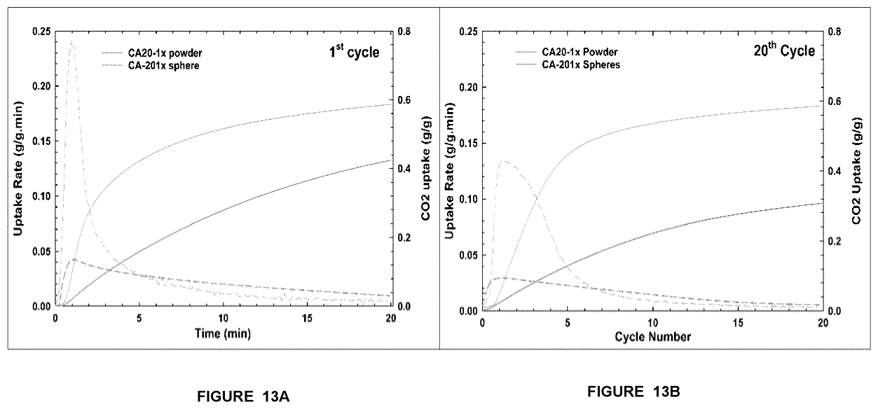

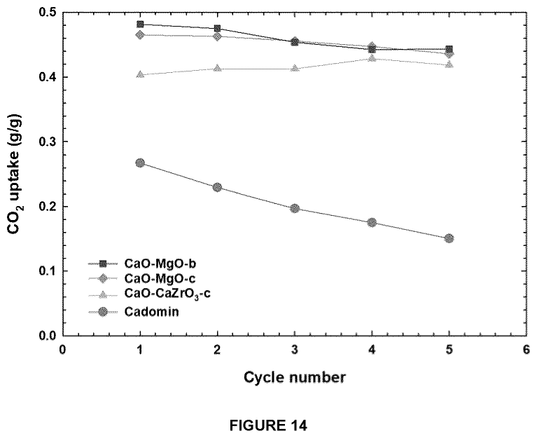

Spheronized particles were prepared and tested in a TGA. FIG. 12 summarizes performance of spheronized sorbents in comparison to as-prepared powders. CA20-1x granules exhibit a reduction in the uptake capacity due to diffusion limitations resulting in lower uptake rates. Uptake capacity and uptake rates for powder and granular sorbents are presented in FIG. 13. For powdered sorbent during the first carbonation cycle the uptake rate is initially very high and eventually levels off approaching equilibrium, indicated by the sharp rate profile. Whereas for the 20^{th} carbonation cycle the maximum rate is reduced and the profile becomes broader. Granular particles exhibit a different behavior, with a very broad rate profile through the entire carbonation period. Based on this observation, a longer carbonation period may be more suitable for spherical particles, since they maintain a significant portion of the initial uptake rate through the remainder of the carbonation cycle. Accordingly, granular sorbents were tested in the TGA under long carbonation period, and results indicate an improved uptake capacity (FIG. 12). Spheronized sorbents were also tested in a fixed and fluidized bed reactor setting to demonstrate operation under relevant conditions. FIG. 14 shows the superior performance of the synthetic pellets compared to natural limestone.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A method of producing a CO₂ sorbent, the method comprising:
(a) combining calcium, at least one metal, and a fuel in a solvent to form a solution;
(b) heating the solution formed in (a) to evaporate the solvent and form a combustion mixture;
(c) heating the combustion mixture formed in (b) to combustion, to form a combusted material; and
(d) calcinating the combusted material formed in (c) to form the CO₂ sorbent.

2. The method of claim 1, wherein the calcium in (a) is a water-soluble calcium salt.

3. The method of claim 2, wherein the water-soluble calcium salt is calcium nitrate or calcium chloride.

4. The method of any one of claims 1 to 3, wherein the calcium in (a) is calcium nitrate (Ca(NO₃)₂·xH₂O), such as Ca(NO₃)₂·4H₂O.

5. The method of any one of claims 1 to 4, wherein the at least one metal is zirconium, magnesium, aluminum, or a rare earth metal such as lanthanum, neodymium, cerium, or ytterbium.

6. The method of any one of claims 1 to 5, wherein the at least one metal is in the form of a water-soluble metal salt.

7. The method of any one of claims 1 to 6, wherein the at least one metal is in the form of a metal nitrate.

8. The method of any one of claims 1 to 7, wherein the at least one metal is ZrO(NO₃)₂·6H₂O, Mg(NO₃)₂·6H₂O, or Al(NO₃)₂·9H₂O.

9. The method of any one of claims 1 to 8, wherein the fuel is citric acid, β-alanine, urea, or ethylenediaminetetraacetic acid (EDTA).

10. The method of any one of claims 1 to 9, wherein the fuel is citric acid.

11. The method of any one of claims 1 to 9, wherein the calcium in (a) is Ca(NO₃)₂·4H₂O, the at least one metal is ZrO(NO₃)₂·6H₂O, and the fuel is citric acid.

12. The method of any one of claims 1 to 11, wherein the solvent in (a) is water, ethylene glycol, or ethanol.

13. The method of any one of claims 1 to 12, wherein the solution in (a) is an aqueous solution.

14. The method of any one of claims 1 to 13, wherein the CO₂ sorbent comprises a stabilizer.

15. The method of claim 14, wherein the stabilizer is a metal oxide.

16. The method of claim 14 or 15, wherein the stabilizer is CaZrO₃, Al₂O₃, MgO, Y₂O₃, CeO₂, La₂O₃, or Nd₂O₃.

17. The method of any one of claims 14 to 16, wherein the stabilizer is CaZrO₃.

18. The method of any one of claims 1 to 17, wherein the CO₂ sorbent has a surface area of about 15 to about 42 m²/g.

19. The method of any one of claims 1 to 18, wherein the CO₂ sorbent has a pore volume of about 0.02 to about 0.12 cm³/g.

20. The method of any one of claims 1 to 19, wherein the heating in (b) is at a temperature of about 20° C. to about 600° C., such as about 100° C.

21. The method of any one of claims 1 to 20, wherein the heating in (c) is at a temperature of about 500° C.

22. The method of any one of claims 1 to 21, wherein the heating in (c) occurs for an amount of time sufficient to combust the fuel, such as less than 1 minute.

23. The method of any one of claims 1 to 22, wherein the calcinating in (d) is at atmospheric pressure and at a temperature of about 700° C. to about 1000° C., such as about 900° C.

24. The method of any one of claims 1 to 22, wherein the calcinating in (d) is under vacuum conditions and at a temperature of about 500° C. to about 1000° C., such as about 500° C.

25. The method of any one of claims 1 to 23, wherein the calcinating in (d) comprises calcinating the combusted material formed in (c) in a furnace.

26. The method of any one of claims 1 to 25, wherein the calcinating in (d) occurs for a period of about 0.5 hours to about 2 hours.

27. The method of any one of claims 1 to 26, further comprising: (e) extruding the CO₂ sorbent formed in (d) to form an extruded material.

28. The method of claim 27, wherein the extruding in (e) comprises combining the CO₂ sorbent formed in (d) with organic and/or inorganic additives in a solvent prior to extruding.

29. The method of claim 27 or 28, wherein the extruding in (e) comprises combining the CO₂ sorbent formed in (d) with cellulose and calcium aluminate cement binder in water and glycerol.

30. The method of any one of claims 27 to 29, further comprising (f) spheronizing the extruded material formed in (e) to form a granular material.

31. The method of claim 30, wherein the granular material formed in (f) comprises spherical particles having average diameters of about 100 μm to about 5 mm, such as about 2 mm to about 3 mm.

32. The method of any one of claims 1 to 31, further comprising (g) pelletizing the CO₂ sorbent formed in (d) or the extruded material formed in (e).

33. A CO₂ sorbent material obtainable or obtained by the method of any one of claims 1 to 32.

34. Use of the CO₂ sorbent material of claim 33 for capturing CO₂.

35. A process for removing CO₂ from a gas stream, the process comprising passing the gas stream over the CO₂ sorbent material according to claim 33.

36. A calcium looping process using the CO₂ sorbent material according to claim 33.
